(19) United States
(12) Patent Application Publication
(10) Pub. No.: US 2007/0115933 A1
(43) Pub. Date: May 24, 2007

(54) Method for maintaining continuity of a multimedia session between media devices

(75) Inventors: Rias Muhamed, Austin, TX (US); David Wolter, Austin, TX (US); Adam Klein, Cedar Park, TX (US); Dinesh Nadarajah, Austin, TX (US)

Correspondence Address: AKERMAN SENTERFITT, P.O. BOX 3188, WEST PALM BEACH, FL, 33402-3188, US

(73) Assignee: SBC Knowledge Ventures LP, Reno, NV (US)

(21) Appl. No.: 11/284,630

(22) Filed: Nov. 22, 2005

(51) Int. Cl. H04L 12/66

(52) U.S. Cl. 370/352; 370/401

(57) ABSTRACT

A system and method are disclosed for maintaining continuity of a multimedia session between media devices. A system that incorporates teachings of the present disclosure may include, for example, a computer-readable storage medium in a multimedia server (112) operating in a service management center (SMC) (100) for managing operations of a plurality of service centers (102-110). The storage medium has computer instructions for receiving (210) a departure mark associated with a multimedia session being presented at a first media device, and transmitting (216) to a second media device from a select one of the service centers the multimedia session starting from the departure mark.

### FIELD OF THE DISCLOSURE

The present disclosure relates generally to multimedia applications, and more specifically to a method for maintaining continuity of a multimedia session between media devices.

### BACKGROUND

The consumer urge for ubiquitous multimedia services such as two-way communications, broadband video services, and gaming—among others—has significantly driven the business model of service providers towards a convergence model. Inevitably consumers will desire to subscribe to multimedia services from a single service provider as opposed to today's environment of many providers each offering disparate services that lack interoperability. As convergence becomes a reality, a need arises for a method for maintaining continuity of a multimedia session between media devices.

### BRIEF DESCRIPTION OF THE DRAWINGS

FIG. 1 is a block diagram of a multimedia server operating in a service management center (SMC) according to teachings of the present disclosure;

FIG. 2 depicts a flowchart of a method operating in the system of FIG. 1 according to teachings of the present disclosure; and

FIG. 3 is a diagrammatic representation of a machine in the form of a computer system within which a set of instructions, when executed, may cause the machine to perform any one or more of the methodologies discussed herein.

### DETAILED DESCRIPTION

Embodiments in accordance with the present disclosure provide a method for maintaining continuity of a multimedia session between media devices.

In a first embodiment of the present disclosure, a computer-readable storage medium in a multimedia server (112) operates in a service management center (SMC) (100) for managing operations of a plurality of service centers (102-110). The storage medium has computer instructions for receiving a departure mark associated with a multimedia session being presented at a first media device, and transmitting to a second media device from a select one of the service centers the multimedia session starting from the departure mark.

In a second embodiment of the present disclosure, a computer-readable storage medium operates in a media device. The storage medium has computer instructions for receiving a multimedia session identification (ID), and a departure mark associated with the multimedia session from an alternate device, and presenting the multimedia session beginning from the departure mark.

In a third embodiment of the present disclosure, a method is presented for reestablishing from a departure mark a multimedia session in transition between media devices.

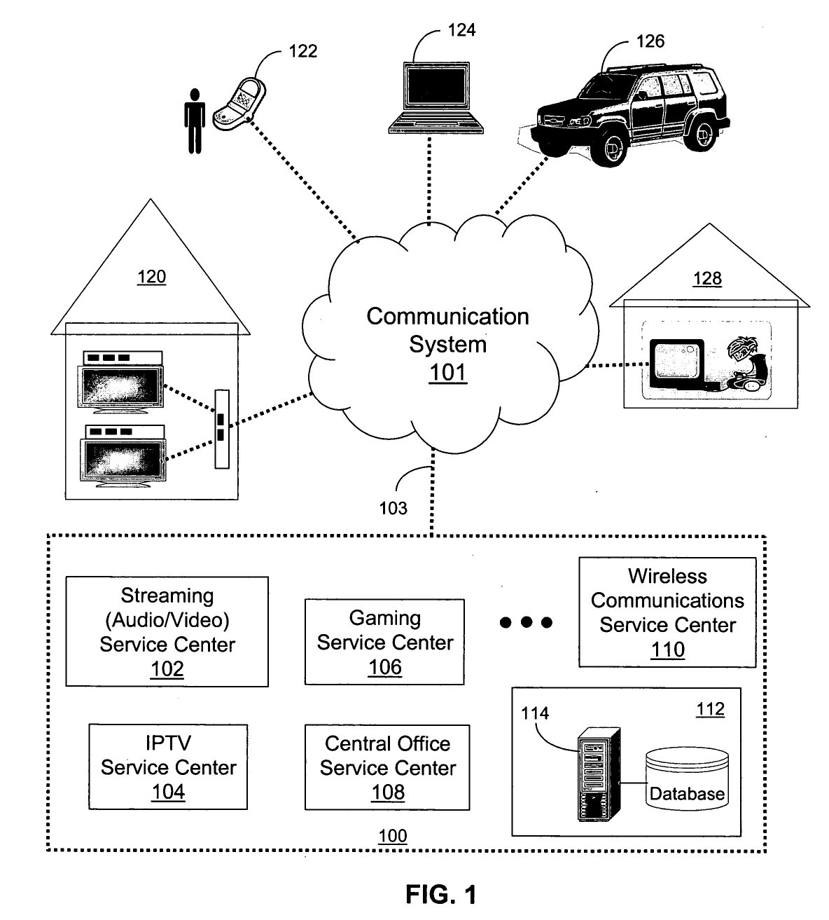

FIG. 1 is a block diagram of a multimedia server 112 operating in a service management center (SMC) 100 according to teachings of the present disclosure. The SMC 100 comprises one or more service centers such as a streaming audio and video service center 102, an Internet Protocol Television (IPTV) service center 104, a gaming service center 106, a central office service center 108, and a wireless communications service center 110, just to mention a few. Each of the service centers is coupled by landline or wireless communication means to the multimedia server 112 which manages the centers. The multimedia server 112 has a controller 114 such as a scalable server with one or more databases managed by applications such as a customer relationship management (CRM) system. Although the service centers 102-110 are shown separately, it would be apparent to one of ordinary skill in the art that portions of the service centers can be integrated with each other and the multimedia server 112.

The streaming audio and video service center 102 can utilize common streaming technology for supplying services such as streaming television, streaming radio service, streaming video on demand, and so on. The IPTV service center 104 can supply consumers a higher quality service such as broadband high definition television (HDTV). The gaming service center 106 can provide consumers game services similar to those available for GameBoy™, GameCube™, PlayStation®, and other gaming applications.

The central office service center 108 provides common landline services such as POTS (Plain Old Telephone Services), voice over IP (VoIP), and/or broadband services such as cable, or xDSL (Digital Subscriber Line). The wireless communications service center 110 can support common wireless services such as cellular communications, dispatch services, WiFi, WiMax, or future technologies such as software defined radio (SDR).

There are numerous media devices available to an end user for interacting with the aforementioned service centers 102-110—some of which are illustrated by way of example in FIG. 1. For example, the end user can have a number of digital and/or analog television sets 120 each residing in a residence with an integrated or external set top box coupled to a residential gateway (or a residential WiFi network). In another embodiment, the end user can utilize a mobile device such as a cell phone 122 (or multimode device) for voice service, location services, and high-speed data communications across one or more access technologies such as cellular, WiFi, and WiMax. In yet another embodiment, an end user can utilize a laptop or desktop computer 124 capable of processing over the Internet multimedia services such as streaming video and audio.

An end user's automobile 126 can include telematics services which collectively can support vehicle tracking and positioning, on-line vehicle navigation and information systems with emergency assistance, and/or broadband entertainment services such as movies, network TV programming, and/or games on demand. An end user can also utilize a common gaming device 128 for playing 2-D and 3-D interactive games downloaded from, or operating at the gaming service center 106 with multiple players competing at single or remote sites.

Connectivity between the media devices 120-126 and the SMC 100 can be accomplished by way of a wired and/or wireless communication link 103 to a communication system 101. The communication system 101 can utilize circuit-switched or packet-switched network technology, or combinations thereof. As a hybrid system, the communication system 101 can support disparate communication technologies such as cellular (or any generation thereof), WiFi, WiMax, landline, optical communications, or SDR. Each of the aforementioned service centers 102-110 can therefore provide by way of the communication system 101 interactive two-way communications, or passive services that terminate at any of the media devices 120-128 accessible to the end user.

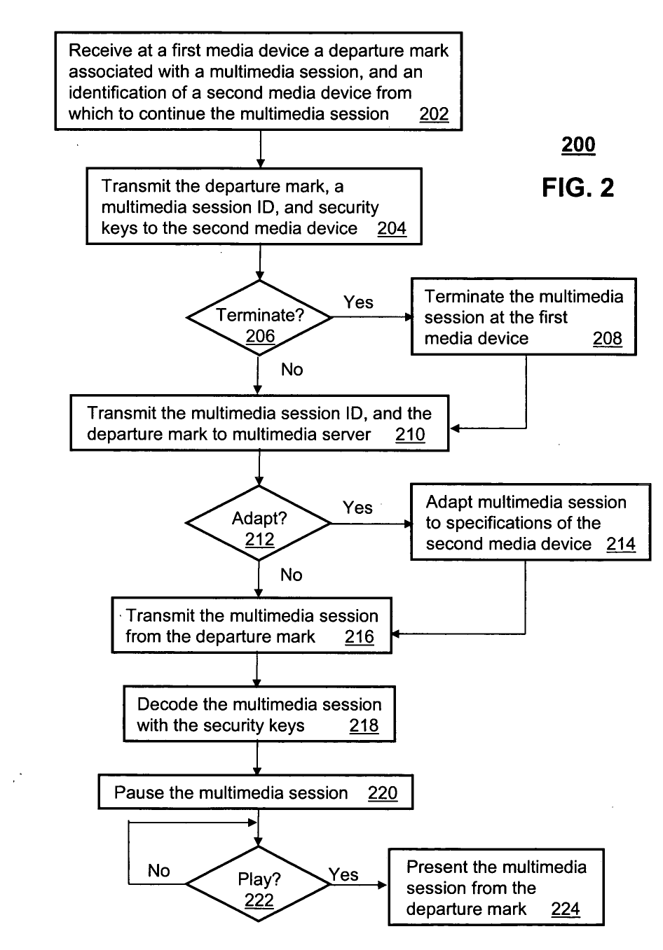

FIG. 2 depicts a flowchart of a method operating in the system of FIG. 1 according to teachings of the present disclosure. Method 200 begins with step 202 where a first media device receives a departure mark associated with a multimedia session, and an identification of a second media device from which to continue the multimedia session. This step can be represented by the following example. Suppose the first media device is one of the television sets in reference 120. Further assume that an end user was watching a sports event (i.e., the media session) on the television unit and has decided to move to another television located in his residence without missing a portion of the programming. To accomplish this, the end user can select on his remote control an option to mark by way of, for example, a time stamp the departure point from which he seeks to transition. Similarly, the end user can select on the remote control an identification of the target television unit (i.e., the second media device) in the home that he plans to transfer to. From this example, the set top box acting as the first media device receives the departure mark and an identification of the second media device.

In step 204, the first media device transmits the departure mark, a multimedia session ID, and security keys to the second media device. From the example above, the multimedia session ID can be the channel selected by the end user on the first television. Thus, the multimedia session ID, the departure mark, and security keys are transmitted from the set top box of the first television set to the set top box of the second television set by way of a residential gateway (or residential network). The security keys can represent encryption key technology which can be used by the set top boxes to prevent misuse of subscriber content.

In step 206 the first media device can decide to terminate in step 208 the multimedia session automatically after step 204, or upon request of the end user. Returning to the present example, the set top box of the first television can end programming upon completing step 204. Alternatively, the end user can turn off the first television with the remote control by depressing the power on/off button, or leave can leave it operating on the same channel for other viewers. In response to step 204, the second media device transmits in step 210 the multimedia session ID, and the departure mark to the multimedia server 112. The controller 114 of the multimedia server 112 determines in step 212 if the multimedia session requires adaptation on the basis of the requesting media device. If so, then the controller 114 proceeds to step 214 where it adapts the multimedia session to specifications of the second media device. Otherwise, the controller 114 proceeds to step 216.

In the present example, going from one television set to another does not require adaptation. However, had the end user transitioned from a television set to his cell phone, adaptation would be required. For instance, the end user may be driving in which case visualizing the same TV program is not possible. Additionally, the specifications of a cell phone dictate a smaller screen, a slower medium for communications, and less computing and storage resources when compared to the television set. Consequently, the controller 114 can, for example, call on the streaming services center 102 to stream only the audio portion of the sports event to the end user's cell phone 122. The streaming service center 102 can request from the IPTV service center 104 a signal feed of the selected multimedia session, or it can pick up the signal feed from the same source used by the IPTV service center 104.

In step 216, the controller 114 causes one of the service centers to transmit the multimedia session from the departure mark (i.e., the point at which the end user transitioned from the first media device). In the present example the controller 114 can cause the IPTV service center 104 to transmit the sports event from the departure mark to the set top box of the second television while continuing original programming on the first television unit (unless, of course, termination step 208 was invoked). In step 218, the second media device decodes the multimedia session with the security keys. In step 220, the second media device can pause the multimedia session by, for example, buffering the signal feed from the IPTV service center 104, or by submitting a request to the IPTV service center to suspend transmission until further notice. Step 220, thus provides the end user time to transition from one media device to another.

In step 222, the second media device waits for a request from the end user to resume play of the multimedia session. If the request is detected, the second media device proceeds to step 224 where it presents the decoded (and possibly adapted) multimedia session from the departure mark. Returning to the television example, step 222 can be invoked by the end user selecting an option on the remote controller to resume previous programming. In the example where the end user transitions from a television set to a cell phone, the invoking step takes place by selecting a function on the cell phone (e.g., a selectable icon from the user interface—UI), or by the act of enabling the cell phone which is detected by the controller 114 by way of the wireless communications service center 110.

It would be evident to one of ordinary skill in the art that the present disclosure can cover countless embodiments not described here. For example, the above example relating to the television can be modified so that the transition takes place from the television to the telematics system of the automobile 126. In this instance, the controller 114 has several options for maintaining continuity of the sports event. For example, the sports event can continue on the television set, while the controller 114 causes the streaming service center 102 to transmit an audio portion of the event to the telematics radio system. In the event there are passengers, the controller 114 can also call on streaming service center 102 to send a video and audio feed of the sports event to the video player of the telematics system. In both cases, the event is submitted from the departure mark. Similarly, method 200 can be applied to a transition between other media devices such as, for example, a transition from the gaming media device 128 to a cell phone, a laptop 124, or the telematics system of the automobile 126.

From the foregoing examples it would be apparent to an artisan with skill in the art that it would be impractical to describe all possible modifications to method 200. For example, the above embodiments can be modified so that the exchanges between media devices as described in method 200 operate instead in whole or in part in the multimedia server 112. This modification as well as other undisclosed embodiments is best understood from a reading of the scope and spirit of the claims described below.

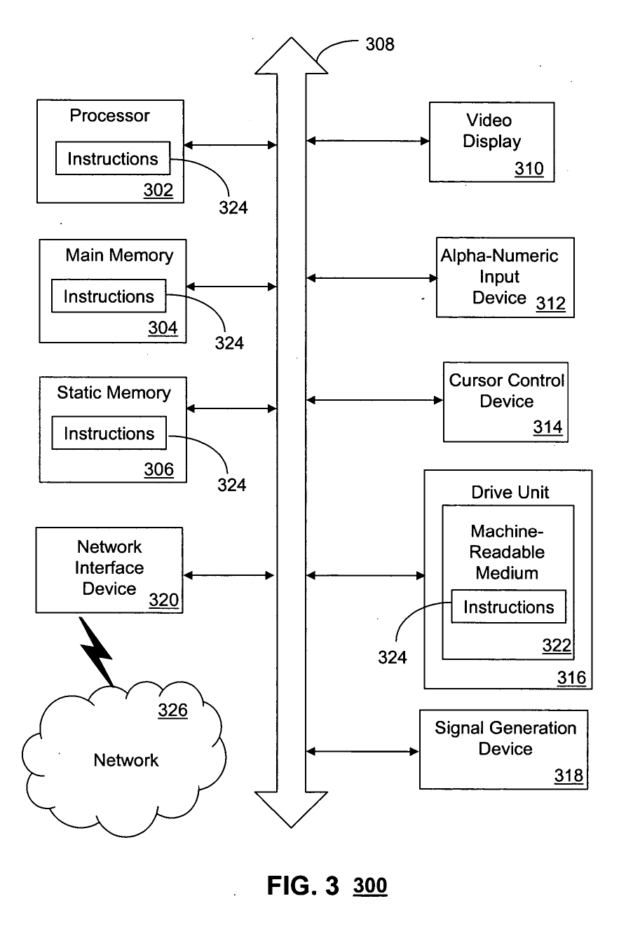

FIG. 3 is a diagrammatic representation of a machine in the form of a computer system 300 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 300 may include a processor 302 (e.g., a central processing unit (CPU), a graphics processing unit (GPU, or both), a main memory 304 and a static memory 306, which communicate with each other via a bus 308. The computer system 300 may further include a video display unit 310 (e.g., a liquid crystal display (LCD), a flat panel, a solid state display, or a cathode ray tube (CRT)). The computer system 300 may include an input device 312 (e.g., a keyboard), a cursor control device 314 (e.g., a mouse), a disk drive unit 316, a signal generation device 318 (e.g., a speaker or remote control) and a network interface device 320.

The disk drive unit 316 may include a machine-readable medium 322 on which is stored one or more sets of instructions (e.g., software 324) embodying any one or more of the methodologies or functions described herein, including those methods illustrated above. The instructions 324 may also reside, completely or at least partially, within the main memory 304, the static memory 306, and/or within the processor 302 during execution thereof by the computer system 300. The main memory 304 and the processor 302 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 324, or that which receives and executes instructions 324 from a propagated signal so that a device connected to a network environment 326 can send or receive voice, video or data, and to communicate over the network 326 using the instructions 324. The instructions 324 may further be transmitted or received over a network 326 via the network interface device 320.

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium in a multimedia server operating in a service management center (SMC) for managing operations of a plurality of service centers, comprising computer instructions for:
receiving a departure mark associated with a multimedia session being presented at a first media device; and
transmitting to a second media device from a select one of the service centers the multimedia session starting from the departure mark.

2. The storage medium of claim 1, comprising computer instructions for continuing an uninterrupted presentation of the multimedia session at the first media device while presenting from the departure mark the multimedia session at the second media device.

3. The storage medium of claim 1, comprising computer instructions for terminating the multimedia session at the first media device after receiving the departure mark.

4. The storage medium of claim 1, comprising computer instructions for:
adapting the multimedia session to specifications of the second media device; and
presenting from the departure mark the adapted multimedia session at the second media device.

5. The storage medium of claim 1, comprising computer instructions for:
receiving from the second media device a multimedia session ID and the departure mark, wherein the departure mark is a time stamp corresponding to when the end user transitioned from the first media; and
enabling the multimedia session at the second media device from the departure mark.

6. The storage medium of claim 1, wherein a multimedia session is at least one among a group of multimedia types comprising text, data, audio, still images, and full motion images.

7. A computer-readable storage medium in a media device, comprising computer instructions for:
receiving a multimedia session identification (ID), and a departure mark associated with the multimedia session from an alternate device; and
presenting the multimedia session beginning from the departure mark.

8. The storage medium of claim 7, comprising computer instructions for:
transmitting the multimedia session ID and the departure mark to a multimedia server; and
receiving from the multimedia server one or more security keys and the multimedia session from the departure mark.

9. The storage medium of claim 7, comprising computer instructions for pausing the multimedia session at the departure mark.

10. The storage medium of claim 9, comprising computer instructions for:
receiving a request to play the multimedia session; and
enabling presentation of the multimedia session from the departure mark.

11. The storage medium of claim 9, comprising computer instructions for acquiring the multimedia session according to the multimedia session ID.

12. The storage medium of claim 7, comprising computer instructions for:
receiving from the alternate device one or more security keys for processing the multimedia session; and
decoding the multimedia session according to the one or more security keys.

13. The storage medium of claim 8, comprising computer instructions for adapting the multimedia session to specifications of the media device.

14. The storage medium of claim 7, comprising computer instructions for:
receiving a second departure mark associated with the multimedia session presented at the media device;
receiving an identification of a desired media device from which to continue the multimedia session; and
transmitting the second departure mark and the multimedia session ID to at least one among the desired media device and a multimedia server.

15. The storage medium of claim 14, comprising computer instructions for terminating the multimedia session upon receiving the second departure mark.

16. A method, comprising reestablishing from a departure mark a multimedia session in transition between media devices.

17. The method of claim 16, comprising the steps of:
receiving at a first media device the departure mark associated with the multimedia session; and
presenting from the departure mark the multimedia session at a second media device.

18. The method of claim 17, comprising the step of continuing an uninterrupted presentation of the multimedia session at the first media device while presenting from the departure mark the multimedia session at the second media device.

19. The method of claim 17, comprising the steps of:
receiving at the second media device a multimedia session identification (ID) and the departure mark associated with the multimedia session transmitted by the first media device; and
presenting from the departure mark the multimedia session at the second media device.

20. The method of claim 17, comprising the steps of:
receiving at the second media device one or more security keys for processing the multimedia session transmitted by the first media device; and
decoding at the second media device the multimedia session according to the one or more security keys.
